(19) United States
(12) Patent Application Publication
(10) Pub. No.: US 2003/0205933 A1
(43) Pub. Date: Nov. 6, 2003

(54) Pneumatic brake booster and method for making same

(76) Inventor: Cedric Leboisne, Paris (FR)

Correspondence Address: Leo H McCormick Jr, 2112 Mishawaka Avenue, PO Box 4721, South Bend, IN, 46634-4721, US

(21) Appl. No.: 10/009,390

(22) PCT Filed: Aug. 31, 2001
(86) PCT No.: PCT/FR01/02722

(30) Foreign Application Priority Data
Sep. 4, 2000 (FR) 00/11497

(51) Int. Cl. B60T 8/44

(52) U.S. Cl. 303/114.3

(57) ABSTRACT

This invention mainly relates to a pneumatic servomotor for an assisted braking, which reduces the noise in the passenger space to the minimum, while not requiring much room in the engine compartment, and it also relates to a motor vehicle equipped with such servomotor.

A pneumatic servomotor (1) for an assisted braking, according to this invention, comprises an air-supply intake (25), opening into the engine compartment (35).

Such a pneumatic servomotor (1) for an assisted braking is provided with a shell defining its outer wall (25), an area (27) of said shell defining an air-supply passage (29), preferably for atmospheric-pressure air, the passage inlet (57) opening into the engine compartment. In an advantageous manner, the area of the outer shell, which defines the passage, corresponds to the rear area, facing the dashboard cross-panel (33), which separates the engine compartment (35) from the passenger space (37). Preferably, the rear area corresponds to the wall of the rear chamber (7), capable of being filled with air at the desired pressure. Advantageously too, the air-supply passage (29) for the servomotor according to the present invention is in the shape of an angular sector which, in a preferred manner, is directed downwards so as to limit the ingress of solid particles and of liquids into the servomotor (1).

The present invention concerns, more particularly, the motor car industry.

And the present invention mainly applies to the design and manufacturing of braking systems.

This invention mainly relates to a pneumatic servomotor for an assisted braking, which reduces the noise in the passenger space to the minimum, while not requiring much room in the engine compartment, and it also relates to a motor vehicle equipped with such servomotor.

It is quite usual to amplify the force, which a driver exerts on a brake pedal, by means of a pneumatic servomotor (also called a “booster”), comprising a variable-volume front chamber, separated from a variable-volume rear chamber by a tight flexible diaphragm and by a rigid skirt driving a pneumatic piston which bears, through a push rod, on the primary piston of a tandem master cylinder of a hydraulic braking system. A first chamber, typically the front chamber, directed towards the tandem master cylinder, is pneumatically connected to a vacuum source whereas a second chamber, typically the rear chamber, in the opposite direction to the front chamber, is pneumatically connected, under a valve control, to a propellant fluid source, typically atmospheric-pressure air.

At rest, that is when the driver does not depress the brake pedal, the front and rear chambers are interconnected, while the rear chamber is isolated from the atmospheric pressure. On braking, first the front chamber is isolated from the rear chamber and then air is admitted into the rear chamber.

The supply of the rear chamber with atmospheric-pressure air results in a flow, which generates a noise likely to be considered quite unpleasant by the passengers of the vehicle.

Besides, the car manufacturer endeavours to reduce the room occupied, in the engine compartment, by the various devices required for the proper running of the vehicle.

Therefore, it is an object of the present invention to provide a pneumatic servomotor for an assisted braking, generating very little noise and vibration in the passenger space.

This object is achieved, in accordance with this invention, by a pneumatic servomotor for an assisted braking, comprising an air-supply intake, opening into the engine compartment.

Another object of this invention consists in providing such a servomotor for an assisted braking, which does not require much space in the engine compartment, so that the room thus unoccupied may be used for the installation of other devices and/or for the reduction of the volume of said engine compartment, e.g. with a view to manufacturing a compacter vehicle.

This object is achieved, in accordance with this invention, by a pneumatic servomotor for an assisted braking, provided with a shell defining its outer wall, an area of said shell defining an air-supply passage, preferably for atmospheric-pressure air, the passage inlet opening into the engine compartment. In an advantageous manner, the area of the outer shell, which defines the passage, corresponds to the rear area, facing the dashboard cross-panel, which separates the engine compartment from the passenger space. Preferably, the rear area corresponds to the wall of the rear chamber, capable of being filled with air at the desired pressure. Advantageously too, the air-supply passage for the servomotor according to the present invention is in the shape of an angular sector which, in a preferred manner, is directed downwards so as to limit the ingress of solid particles and of liquids into the servomotor.

The servomotor in accordance with the invention is advantageously provided with a rear sealing and protective casing, which protrudes into the passenger space, through an opening made in a dashboard cross-panel, separating the engine compartment from the passenger space.

In an advantageous manner, the sealing and protective casing comprises an area, projecting into the engine compartment, opposite the area of the rear wall of the servomotor, in which a supply passage is provided. At the air-supply passage, said area of the sealing and protective casing constitutes the opposite wall of such passage.

The main subject of this invention is a pneumatic servomotor for an assisted braking of a motor vehicle, comprising a first chamber, defined by an outer rigid wall and separated, by means of a tight diaphragm, from a second chamber, which is also defined by an outer rigid wall, said diaphragm resting on a rigid piece, which drives the pneumatic piston on the controlled variations of the capacities of said first and second chambers, connecting means arranged between the first chamber and a vacuum source, and a control valve for the admission into said second chamber, on actuation, of an air pressure from an air inlet, characterised in that the outer rigid wall of one of said first and second chambers defines a radial air-supply passage for one of said chambers, said passage having an inlet capable of opening into the engine compartment.

The present invention also deals with a servomotor, characterised in that the space occupied by the radial passage is situated toward the inside of the rear chamber, so as to minimise an increase Δ of the length e of the servomotor.

Another subject matter still of the present invention is a servomotor, characterised in that the inlet of the radial passage opens downwards in the operating state.

According to another aspect of the invention, a servomotor is characterised in that said outer rigid wall, defining said passage, comprises an area for the attachment of the servomotor to the dashboard cross-panel of a motor vehicle.

The present invention also deals with a servomotor, characterised in that it comprises reinforcing tie bars, arriving at said attachment area in the dashboard cross-panel of a motor vehicle.

Another subject matter still of the present invention is a servomotor, characterised in that it comprises a sealing and protective casing for a rear part of the servomotor, said casing being housed within the passenger space.

According to another aspect of the invention, a servomotor is characterised in that the sealing and protective casing defines an air-supply passage, connecting said radial passage to an opening at the rear part of the pneumatic piston.

Another subject of the invention is a motor vehicle, characterised in that it comprises an engine compartment, separated from a passenger space by means of a dashboard cross-panel and in that a servomotor according to any preceding aspects is attached to said dashboard cross-panel.

This invention also deals with a motor vehicle, characterised in that the servomotor is rigidly linked up with the dashboard cross-panel by means of tie bars, traversing said outer rigid wall, in a radial area of the casing and of the dashboard cross-panel.

Another subject matter still of the present invention is a manufacturing process for a pneumatic servomotor intended for an assisted braking, characterised in that it includes a deformation step, carried out on an outer rigid wall so as to form an air-supply passage, and an assembling step to fit together the outer rigid wall and other elements, making up said servomotor.

Other features and advantages of the present invention will be apparent from the following detailed description, by way of example and by no means as a limitation, when taken in conjunction with the accompanying drawings, in which:

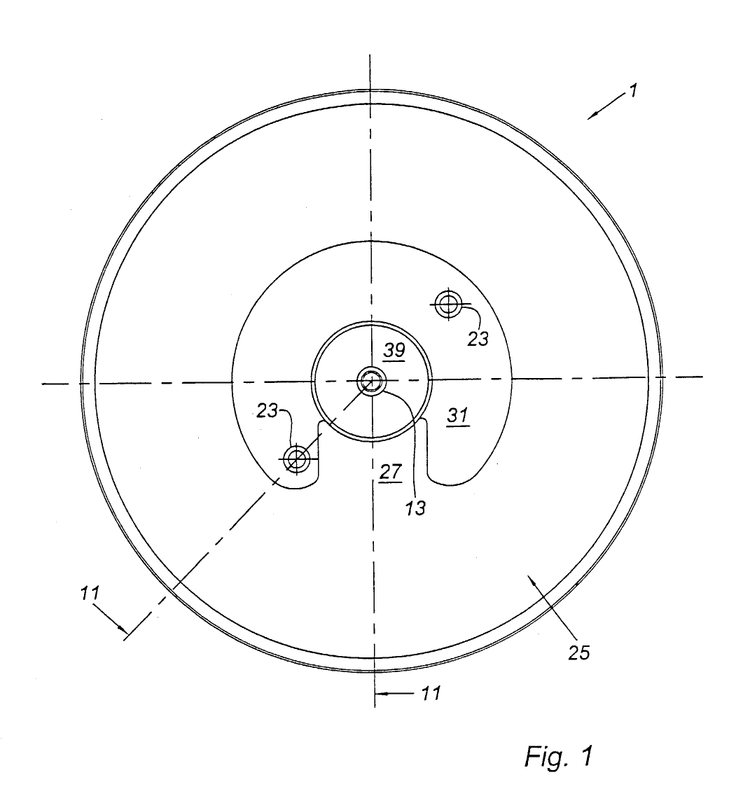

FIG. 1 is a rear view of the preferred embodiment of a pneumatic servomotor for an assisted braking according to this invention ; and

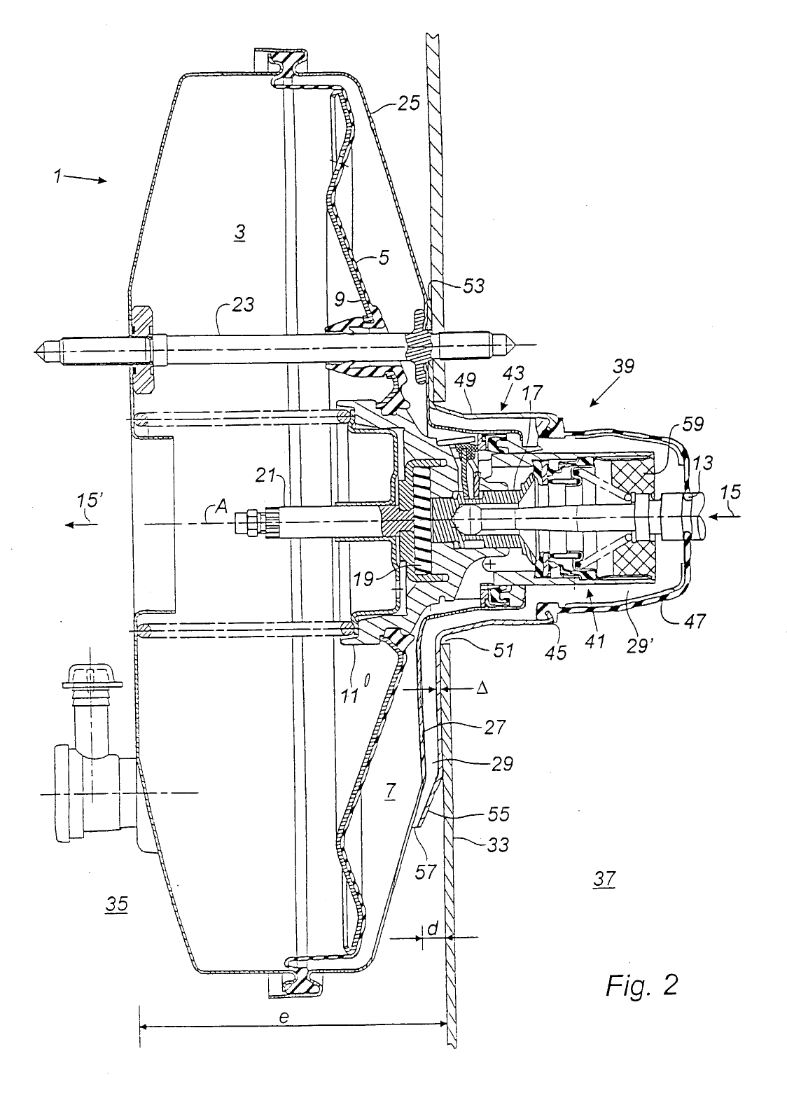

FIG. 2 is a sectional view of the servomotor, taken along line II-II of FIG. 1.

In FIGS. 1 and 2, the same reference numerals will designate the same elements.

FIGS. 1 and 2 show a pneumatic servomotor 1 for an assisted braking according to the preferred embodiment of the present invention, which comprises a front chamber 3, separated from a rear chamber 7 by a tight diaphragm 5. The diaphragm 5 rests on a rigid skirt 9, driving a pneumatic piston 11 at the time of the volume variation of said chambers 3 and 7. A control rod 13, capable of being driven in the direction of the arrow 15 by a brake pedal (not shown), bears on a distributor plunger 17, bearing itself on a reaction disk 19, made of an incompressible material, such as an elastomer, and arranged in a chamber at least one wall of which is integral with a push-rod 21, resting on a primary piston of a tandem master cylinder (not shown). This distributor plunger 17 controls, in a well-known manner, a valve fitted with a first flap which shuts off, on actuation, a passage connecting the front chamber 3 with the rear chamber 7 of the servomotor 1, and a second flap which opens, on actuation, the air-supply passage of the rear chamber 7 of said servomotor. The flap seats are axially offset in such a way that the forward travel of the control rod 13 in the direction of the arrow 15, in the first place, closes the first flap, thus tightly separating the front chamber 3 from the rear chamber 7, and then opens the second flap so as to supply the rear chamber 7 of the servomotor with air. Thus, the atmospheric-pressure air rushes into the rear chamber 7, in a controlled manner, and the pressure difference, exerted on the skirt 9, moves the pneumatic piston 11 forward for the desired braking assistance.

In the particularly advantageous embodiment as illustrated, the servomotor 1 comprises axial-stiffening means, such as two tie bars 23, running parallel to the axis A of the servomotor and arranged symmetrically about said axis. In a well-known manner, the use of such tie bars 23 for the stiffening of the servomotor makes it possible to reduce the thickness of the jacket of the servomotor and, in consequence, its weight. Besides, the rear wall 25 does not significantly contribute any longer to the stiffness of the servomotor so that, according to this invention, this wall can be deformed in a given area 27, so as to form a radial passage 29 for the atmospheric-pressure air supply of the chamber 7, i.e. substantially perpendicular to the axis A and thus substantially parallel to the dashboard cross-panel 33. It results in an area 31 of the rear wall 25, which is available for the attachment to the dashboard cross-panel 33, separating the engine compartment 35 from the passenger space 37. In the preferred embodiment, the area 31 includes the through-holes for the tie bars 23, which are rigidly fastened to the dashboard cross-panel 33, and it partly encompasses, for instance with an angle substantially equal to 270°, the base of a sealing and protective casing 39, intended for the rear part 41 of the servomotor 1. The boundaries between the areas 27 and 31 are formed, for instance, by two segments of a line, which are tangent to the substantially circular base of the casing 39 and parallel to each other. The casing 39 comprises a rigid front part 43 including, in the back-to-front direction, an anchoring area 45 of a flexible part 47 of the casing 39, such area being connected to a substantially tubular part 49, which flares and goes through a circular or substantially circular opening 51, made in the dashboard cross-panel 33; and in an area 53, the rigid part 43 is substantially parallel to the dashboard cross-panel 33. In an advantageous manner, said area 53 is sandwiched between the area 31 of the wall 25 and the dashboard cross-panel 33.

Advantageously too, the part of the area 53, facing the area 27, cooperates with the latter to as to define the passage 29. In a preferred manner, at this spot, it is fitted with a flange in the direction of the rear wall 25, which forms an inlet 57 of the passage 29. It should be noted that, if the rear wall 25 lies close against the dashboard cross-panel 33, via the area 31, the length e required by the servomotor 1 in the engine compartment 35 may be reduced. For instance, the passage 29 has a depth d ranging from 0.1 to 10 mm, preferably from 0.2 to 5 mm, and e.g. equal to 3 mm. The suction cross-section area of the passage 29 ranges, for instance, from 5 mm² to 500 mm², preferably from 50 mm² to 300 mm² and, still more preferably, from 100 mm² to 250 mm², for instance it amounts to 150 mm², 200 mm² or 250 mm². In a particularly advantageous manner, the passage 29 is formed toward the inside of one of the chambers (the rear chamber 7 in the present embodiment). The fact that the available capacity of the chamber 7 is reduced, owing to the space occupied by the passage 29 in the rear chamber 7, is of no consequence whatsoever as regards the functional performance of the pneumatic piston 11, while reducing the space required by the servomotor 1 in the engine compartment. In the advantageous example as illustrated, the increase Δ of the space required owing to said passage actually corresponds to the distance e between the front face of the servomotor and the rear face of an area 31 for the attachment to the dashboard cross-panel 33, compared with a servomotor, an air intake of which would be located in the passenger space, and it is equal to the thickness of the area 53 of the casing 39. Such thickness Δ is e.g. equal to 0.5 mm. Besides, the servomotor 1 is directly fastened, in a most effective manner, to the dashboard cross-panel 33, thus without requiring any additional intermediate elements.

Since the flexible part 47 of the casing 39 is made, for instance, of an elastomer, it is capable of accompanying the axial motions of the control rod 13.

The air-supply passage 29 extends, in the radial direction, into a passage 29′, located between the flexible part 47 of the casing 39 and the rear part of the pneumatic piston 11, so as to let the air flow through the rear opening 59 of the pneumatic piston 11, which is advantageously fitted with a filter, preventing any contaminants from penetrating to the valve and the chambers 3 and 7.

In an advantageous manner, the area 27 is obtained by a cold deformation, e.g. by stamping, of the rear wall 25 in the case of a sheet metal (as shown), typically a steel or an aluminium sheet, or by a moulding process if the rear wall is made of a plastic.

It is to be understood that the present invention is in no way restricted to the above-described advantageous embodiment. Thus, the servomotors for an assisted braking, without tie bars and/or the servomotors, the front chamber 3 of which may be supplied with atmospheric-pressure air, whereas the rear chamber 7 is connected to a vacuum source, do not depart from the scope of this invention.

The present invention concerns, more particularly, the motor car industry.

And the present invention mainly applies to the design and manufacturing of braking systems.

1. Pneumatic servomotor for an assisted braking of a motor vehicle, comprising a first chamber (3), defined by an outer rigid wall and separated, by means of a tight diaphragm (5), from a second chamber (7), which is also defined by an outer rigid wall (25), said diaphragm (5) resting on a rigid piece (9), which drives the pneumatic piston (11) on the controlled variations of the capacities of said first and second chambers (3, 7), connecting means arranged between the first chamber (3) and a vacuum source, and a control valve for the admission into said second chamber (7), on actuation, of an air pressure from an air inlet, characterised in that the outer rigid wall (25) of one of said first and second chambers (3, 7) defines a radial air-supply passage (29) for one of said chambers (3, 7), said passage (29) having an inlet (57) capable of opening into the engine compartment (35).

2. Servomotor according to claim 1, characterised in that the space occupied by the radial passage (29) is situated toward the inside of the rear chamber (7), so as to minimise an increase Δ of the length e of the servomotor (1).

3. Servomotor according to claim 1 or 2, characterised in that the inlet (57) of the radial passage (29) opens downwards in the operating state.

4. Servomotor according to claim 1, 2 or 3, characterised in that said outer rigid wall (25), defining said passage (29), comprises an area (31) for the attachment of the servomotor (1) to the dashboard cross-panel (33) of a motor vehicle.

5. Servomotor according to claim 4, characterised in that it comprises reinforcing tie bars (23), arriving at said area (31) for the attachment to the dashboard cross-panel (33) of a motor vehicle.

6. Servomotor according to any one of the preceding claims, characterised in that it comprises a sealing and protective casing (39) for a rear part (41) of the servomotor (1), said casing being housed within a passenger space (37) of the motor vehicle.

7. Servomotor according to claim 6, characterised in that the sealing and protective casing (39) defines an air-supply passage (29′), connecting said radial passage (29) to an opening (59) at the rear part of the pneumatic piston (11).

8. Motor vehicle, characterised in that it comprises an engine compartment (35), separated from a passenger space (37) by means of a dashboard cross-panel (33), and in that a servomotor (1) according to any one of the preceding claims is attached to said dashboard cross-panel (33).

9. Motor vehicle according to claim 8, characterised in that the servomotor (1) is rigidly linked up with the dashboard cross-panel (33) by means of tie bars (23), traversing said outer rigid wall (25), in a radial area (53) of the casing (39) and of the dashboard cross-panel (33).

10. Manufacturing process for a pneumatic servomotor intended for an assisted braking according to any one of claims 1 to 7, characterised in that it includes a deformation step, carried out on an outer rigid wall (25) so as to form an air-supply passage (29), and an assembling step to fit together the outer rigid wall (25) and other elements, making up said servomotor (1).
